(19) United States
(12) Patent Application Publication
(10) Pub. No.: US 2006/0260717 A1
(43) Pub. Date: Nov. 23, 2006

(54) Universal Split & Turn Log Splitter Foot Attachment

(76) Inventor: William R. Bowers, Dallas, GA (US)

Correspondence Address: GEORGE R. REARDON, 3356 STATION COURT, LAWRENCVILLE, GA, 30044, US

(21) Appl. No.: 11/419,196

(22) Filed: May 18, 2006

Related U.S. Application Data
(60) Provisional application No. 60/681,985, filed on May 18, 2005.

(51) Int. Cl. B27L 7/00

(52) U.S. Cl. 144/193.1

(57) ABSTRACT

A rotating foot accessory for a log splitting device is disclosed that allows the user to turn the log by hand during the splitting process. The rotatable foot assembly attaches to the foot portion of a portable vertical/horizontal log splitter and is comprised of a disk assembly and a mounting assembly. The mounting assembly can be releasably attached to the foot portion and is operable for allowing the disk assembly to rotate or to remain stationary.

This application claims the benefit of U.S. Provisional Patent Application No. 60/681,985, filed May 18, 2005.

### FIELD OF THE INVENTION

The present invention relates to the field of accessories that are attachable to a wood splitting apparatus.

### BACKGROUND OF THE INVENTION

Wood is used as both as an energy source and for the ambiance created by a wood burning fireplace. In order to use the wood effectively log sections need to be split into smaller units. Powered wood splitters are very useful to east the burdensome task of splitting large quantities of firewood blocks.

It is advantageous that the blade and platform of these powered wood splitters be oriented for relative movement in a vertical plane for convenience in loading and operation. Many splitters have therefore been developed with splitting frames that may be selectively moved between horizontal and vertical positions. Most are operable in the horizontal position which also represents a transport position to facilitate transport of the splitter from one location to another. The vertical position is utilized primarily for operation of the splitter to ease positioning of the wood blocks without requiring excessive manual lifting.

Devices such as the TROY-BILT Vertical/Horizontal Log Splitter, and similarly constructed devices having cast iron or durable splitting wedges, allow users to quickly make a stack of firewood out of large trees and logs. These devices have a tongue that ends in a foot that engages the ground surface to stabilize the unit. The shape of this foot varies slightly depending on the model and manufacturer.

One problem with the aforementioned devices is that when a log is split, each section must be lifted back into place to be split into smaller sections. This not only requires additional effort and takes additional time, but also increases the chances of back injury.

The prior art does not provide an accessory for the foot portion of these devices that enables the user to rotate the log during the splitting operation, thus saving time and reducing the chance of back injury.

Related art includes the following patents.

U.S. Pat. No. 4,239,198, issued to William H. Trupp on Dec. 16, 1980, discloses a holder for supporting a log in a vertical position to be split. The holder is formed of three interconnected horizontally extending support members and an adjustable retainer having a curved collar thereon is slidably mounted on each support member to hold the log in position. A screw or wedge locking means is used to hold the adjustable retainers in the desired position on the support members.

U.S. Pat. No. 4,275,779, issued to William D. Rowe on Jun. 30, 1981, discloses an adjustable log-splitting apparatus of the type wherein a wedge-shaped cutter is slidably received on a vertical column for splitting logs placed therebeneath includes the improvement of a base platform having a top plate member and a supporting frame member wherein the top plate member is able to be raised by a foot treadle and once raised, is able to be manually rotated about a central pivot axis relative to the supporting frame member. Pivotal movement of the top plane member relative to the supporting frame member is achieved by means of a cylindrical post which is both slidably and pivotally received within a closely sized aperture. In a static condition, the top plate member rests on the outer periphery edge of the supporting frame member. However, when the foot treadle is depressed, four rollers are pivoted into a raised orientation thereby drawing these rollers into direct contact with the underside of the top plate member and actually raising the top plate member up off of the supporting frame member. The action which brings these rollers into contact with the underside of the top plate member also orients the axis of rotation of these rollers into the same horizontal plane and each axis line intersects the axis of rotation of the top plate member relative to the supporting frame member.

U.S. Pat. No. 4,515,195, issued to Harvey Gladstein, on May 7, 1985, discloses a log or piece of cord wood that is supported upright on a base member between two support members which are secured to the base member so that at least one support member is movable toward and away from the other. The base member is sufficiently large to permit a user to stand thereon to positionally stabilize the base member while a log is being split. The support members are prevented from moving inadvertently during splitting by various alternative means such as of frictionally engaging one or both support members in tracks, spring biasing the support members toward one another, positionally locking a movable support member or by detenting the support members in various positions. The support members have concave surfaces extending at least 90.degree. around and sufficiently high so as to preclude movement of the log during splitting.

U.S. Pat. No. 4,535,980, issued to Ross W. Jordan on Aug. 20, 1985, discloses a log holder for holding a log in a position to facilitate splitting of the log, the log holder having a plurality of diverging wall members joined to each other at the rear edges. The log holder is provided with means for supporting the wall members at an angle such that the junction of the rear edges slopes rearwardly from bottom to top. The log is placed between the diverging wall members and is held by gravity in a position inclined with respect to the vertical. Arms are provided to prevent the split pieces of the log from flying sideways. The restrained pieces are held in position for further splitting, or for pick-up with less stooping. Provision is also made for supporting a tool or tools on the log holder in a position for quick access where they do not interfere wtih the chopping action. The sheet metal members are secured to an angle iron which may be driven into the ground or in a modified form, secured to a supporting framework resting on the ground. A block of wood may be recessed in the ground beneath where the log rests so as to provide a chopping block which the axe hits when the wood is split.

U.S. Pat. No. 4,553,576, issued to Gérard Maingueneau on Nov. 19, 1985, discloses a log splitter having a rotatable cone driven by a reversible motor. A system of lever arms support a log in a V-shaped carrier positioned under the point of the cone. When the lever arm is operated, the log is pushed against the point of the rotating cone, which splits the log. If the log fails to split, the motor is driven in the reverse direction, which releases the log.

U.S. Pat. No. 4,700,759, issued to Dennis Duerr on Oct. 20, 1987, discloses a blade type wood splitter including a blade guarding housing that is movable along with the blade to engage a wood block prior to contact of the block by the cutting edge of the blade. The housing rests against the wood block as the blade is driven through and later is retracted with the blade following the splitting operation. The housing includes a peripheral wood engaging edge that substantially circumscribes the cutting edge of the blade and is normally spaced therefrom toward the platform on which the wood blocks are received. This edge may first engage the wood block as the blade is moved toward splitting contact with the block. The edge may therefore provide ample warning to an operator who has inadvertently placed fingers in the path of the blade by contacting the fingers before the blade descends to cause injury. The housing also functions as a stripping device for allowing withdrawal of the blade from between binding pieces of wood by holding the wood stationary as the blade is retracted. The housing also includes outwardly flared walls for engagement with adjacent wood surfaces to hold the wood in position and to resist outward “kick out” of the split sections.

U.S. Pat. No. 4,782,870, issued to Dennis Duerr on Nov. 8, 1988, discloses a portable wood splitter having a splitter frame adjustably mounted to a support frame. In one embodiment the support frame is wheel supported and in another embodiment the support frame is mountable to a vehicle such as a tractor for transport. The splitter includes a splitter beam with a blade mounting slide plate powered to move toward and away from a platform at a lower beam end. The slide plate includes safety features to avoid finger injury. A double gib adjustment on the slide plate facilitates adjustment for wear and enables centering adjustments of the blade on the beam. The beam is mounted to the support frame by a clamp arrangement that will facilitate selective longitudinal adjustment of the beam relative to the frame. The beam is pivotal, on the first embodiment between a horizontal position overlying a towing tongue and an upright position. An adjustment feature enables re-positioning of the towing tongue from its horizontal operative position to an upright compact condition where an end of the tongue engages the ground surface to stabilize the unit.

While these patents and other previous methods have attempted to solve the problems that they addressed, none have utilized or disclosed utilizing a rotating foot accessory for a log splitting device, as does embodiments of the present invention.

Therefore, a need exists for a rotating foot accessory for a log splitting device with these attributes and functionalities. The rotating foot accessory for a log splitting device according to embodiments of the invention substantially departs from the conventional concepts and designs of the prior art. It can be appreciated that there exists a continuing need for a new and improved rotating foot accessory for a log splitting device which can be used commercially. In this regard, the present invention substantially fulfills these objectives.

The foregoing patent and other information reflect the state of the art of which the inventors are aware and are tendered with a view toward discharging the inventors' acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a log splitting accessory. In particular, the present invention relates to a device that allows the user to turn the log by hand during the splitting process.

The present invention specifically relates to a system comprised of a selectively rotatable assembly that attaches to the foot portion of a portable vertical/horizontal log splitter, e.g. a TROY-BILT Vertical/Horizontal Log Splitter 33-Ton Capacity.

The present invention is comprised of a disk assembly and a mounting assembly.

The disk assembly is comprised of a disk having a central hole and a hub assembly that is disposed within that central hole. The hub assembly is further comprised of an axle, a top hub cap and a bottom hub cap.

The mounting assembly is comprised of a main support having a hub hole, a disk locking bolt hole and a plurality of mounting bar holes. The mounting assembly is further comprised of at least one set of mounting bars, preferably two sets, that can be secured to the log splitter foot by bolts and nuts through the mounting bar holes. The portion of the main support having the hub hole and disk locking bolt hole is dimensioned to abut the distal end of the log splitter foot.

One aspect of the present invention is that it helps the user to split more wood faster.

Another aspect of the present invention is that is reduces the chance of back injury.

Another aspect of the present invention is that it can be made inexpensively.

Another aspect of the present invention is that it can be made of readily available materials.

Another aspect of the present invention is that it is easy to install.

Another aspect of the present invention is that it is easy to use.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a top perspective view of a rotating foot accessory for a log splitting device according to one embodiment of the present invention.

FIG. 2 illustrates rear plan view of a rotating foot accessory for a log splitting device according to one embodiment of the present invention.

FIG. 3 illustrates a right plan view of a rotating foot accessory for a log splitting device according to one embodiment of the present invention.

FIG. 4 illustrates a rear plan view of a portion of the assembly for a rotating foot accessory for a log splitting device according to one embodiment of the present invention.

FIG. 5 illustrates a front plan view of a portion of the assembly for a rotating foot accessory for a log splitting device according to one embodiment of the present invention.

FIG. 6 illustrates a front plan view of an axle for a rotating foot accessory for a log splitting device according to one embodiment of the present invention.

FIG. 7 illustrates a top plan view of an disk for a rotating foot accessory for a log splitting device according to one embodiment of the present invention.

FIG. 8 illustrates a top plan view of a set of mounting bars for a rotating foot accessory for a log splitting device according to one embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

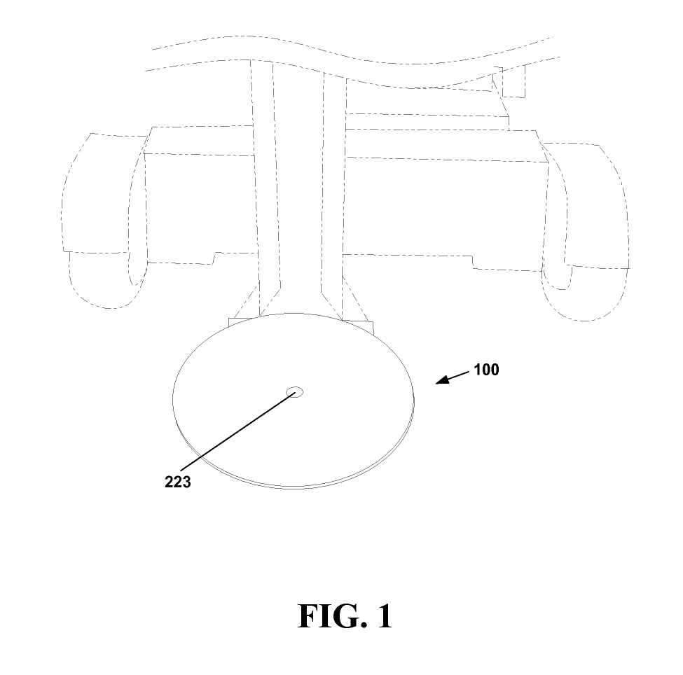

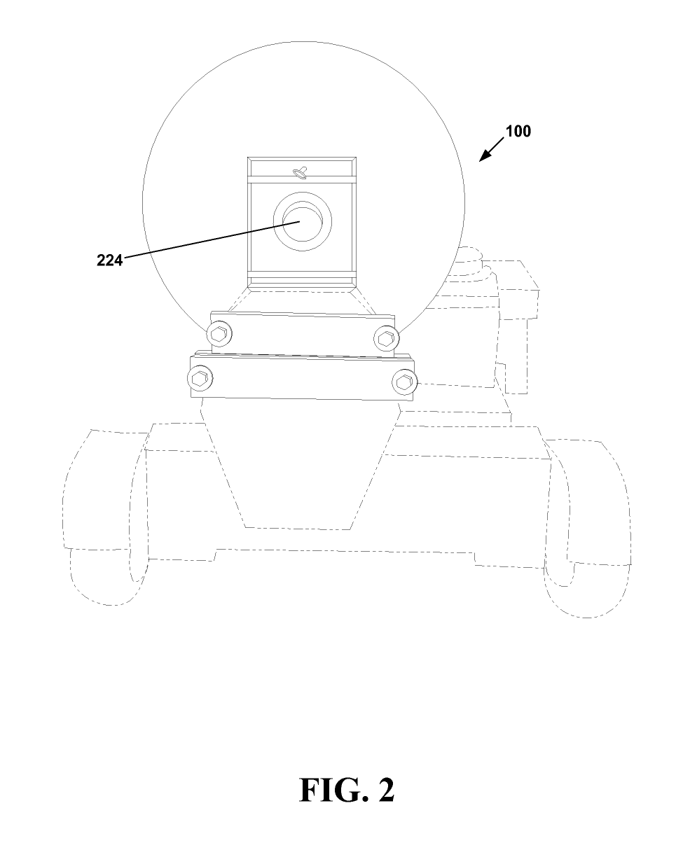

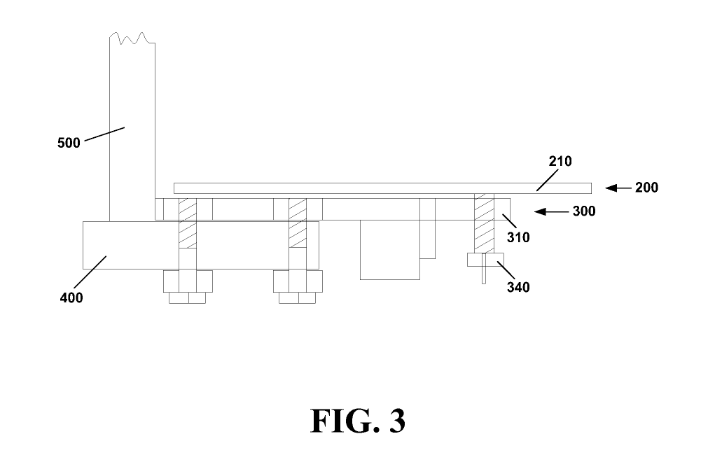

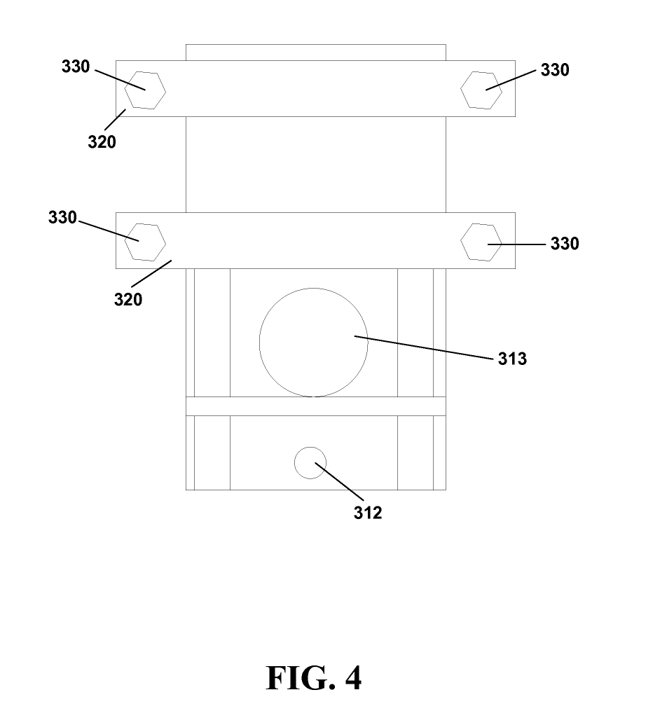

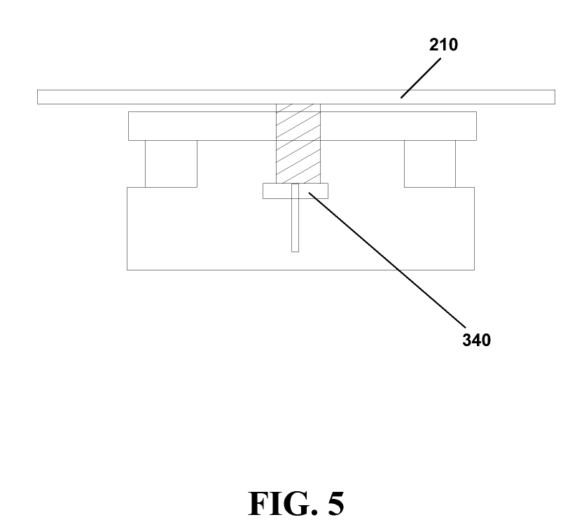

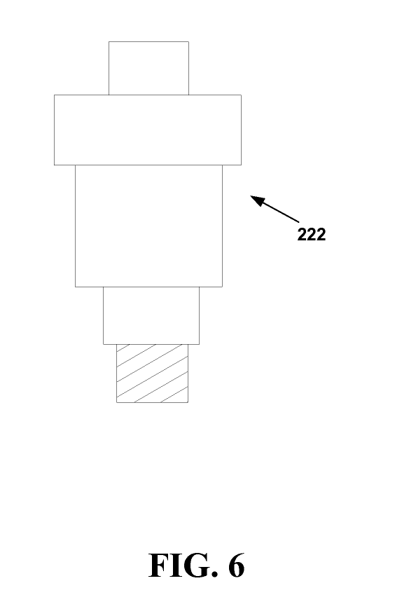

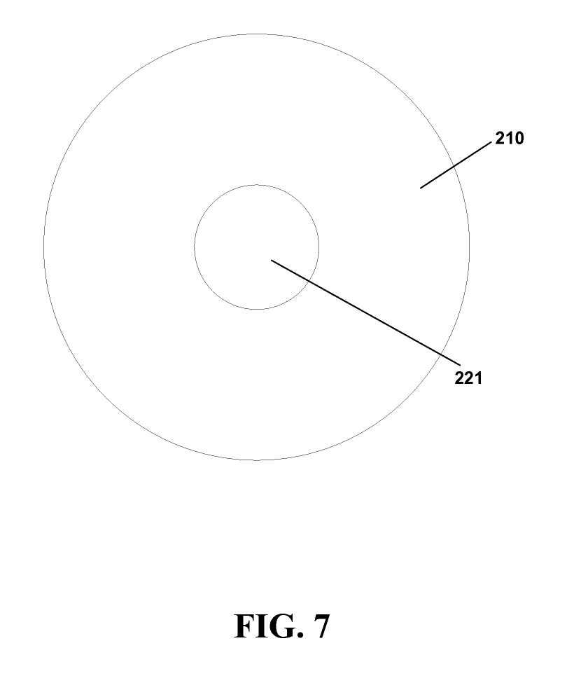

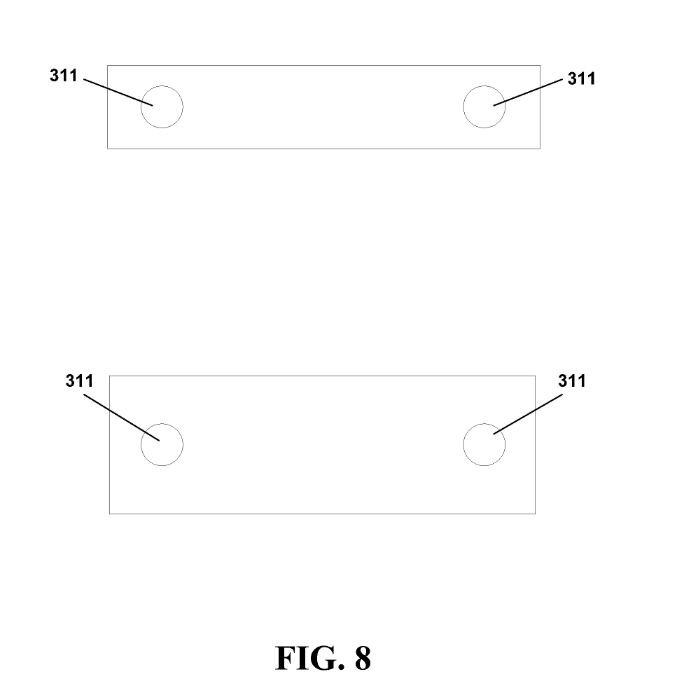

Referring now to FIG. 1 through FIG. 8, a rotatable assembly 100 is comprised of a disk assembly 200 and a mounting assembly 300. The mounting assembly 300 is attached to a log splitter foot 400 that is connected to a log splitter main post 500. The disk assembly 200 is placed on top of the mounting assembly 300 as illustrated.

The disk assembly is comprised of a disk 210 having a disk hub hole 211 in its center as illustrated. The disk assembly is further comprised of a hub assembly disposed within the disk hub hole 221. The hub assembly is comprised of an axle 222, a top hub cap 223 and a bottom hub cap 224.

The mounting assembly 300 is comprised of a main support 310 having a hub hole 313, a disk locking bolt hole 312, and a plurality of mounting bar hole 311. The mounting assembly 300 is further comprised of at least one set of mounting bar 320. The mounting assembly 300 is further comprised of a plurality of mounting bar bolt 330 that secures the mounting assembly 300 to the log splitter foot 400 by installation through the mounting bar hole 311. The mounting assembly 300 is further comprised of disk locking bolt 340 that is installed in disk locking bolt hole 312. Disk locking bolt 340 is operable for selectively preventing disk 210 from rotating or allowing disk 210 to rotate freely.

From the foregoing, it will be appreciated that, although specific embodiments of the invention have been described herein for purposes of illustration, various modifications may be made without deviating from the spirit and scope of the invention. For example, many of the features and components described above in the context of a particular rotatable assembly configuration can be incorporated into other configurations in accordance with other embodiments of the invention. Accordingly, the invention is not limited except by the appended claims.

What is claimed is:

1. A log splitter foot attachment comprising:
means for attaching to a log splitter foot; and
means for rotating a log, wherein the means for rotating is placed on the means for attaching.

2. The log splitter foot attachment as recited in claim 1, wherein the means for attaching consists of a mounting assembly comprised of a main support having a main support hub hole, a disk locking bolt hole and a plurality of mounting bar hole, wherein the mounting assembly is further comprised of a plurality of mounting bar releasably attached to the main support with a plurality of mounting bar bolt installed in the plurality of mounting bar hole, wherein the mounting assembly is further comprised of a disk locking bolt installed in the disk locking bolt hole.

3. The log splitter foot attachment as recited in claim 2, wherein the means for rotating is comprised of a disk assembly comprised of a disk having a disk hub hole with a hub assembly disposed within the hub hole, wherein the hub assembly is operable for rotational fitting into the main support hub hole.
